(19) United States
(12) Patent Application Publication
(10) Pub. No.: US 2013/0076557 A1
(43) Pub. Date: Mar. 28, 2013

(54) ELECTROMAGNETIC SENSOR

(71) Applicants: Andrew Shaw, Liverpool (GB); Ahmed Al-Shamma'a, Liverpool (GB)

(72) Inventors: Andrew Shaw, Liverpool (GB); Ahmed Al-Shamma'a, Liverpool (GB)

(73) Assignee: LIVERPOOL JOHN MOORES UNIVERSITY, Merseyside (GB)

(21) Appl. No.: 13/642,271

(22) PCT Filed: Apr. 21, 2011
(86) PCT No.: PCT/GB11/50796

§ 371 Date: Dec. 13, 2012

(30) Foreign Application Priority Data
Apr. 22, 2010 (GB) 1006733.8

(51) Int. Cl. F17D 5/06; G01S 13/89

(52) U.S. Cl. CPC F17D 5/06; G01S 13/89
USPC 342/22

(57) ABSTRACT

Disclosed is a probe for use in a fluid pipeline, comprising: a transmitter for transmitting an RF signal via an antenna (50); a receiver for receiving an RF signal via an antenna; a processor operable to compare the received signal with an expected signal. Also disclosed is a method of assessing the condition of a pipeline by means of a probe located inside the pipeline, comprising the steps of: transmitting an RF signal from the probe; receiving an RF signal at the probe; comparing the received and an expected signal and, based on the result of the comparison, indicating that the pipeline is acceptable or not.

The present invention relates to a sensor and associated method for use in locating leaks or discontinuities in a liquid-carrying pipeway, particularly, but not exclusively, a live water mains. Apparatus according to an embodiment of the invention can also be used in asset management applications.

Presently, leaks in water mains pipelines account for a significant waste of treated water, resulting in increased prices for consumers and considerable inconvenience when remedial work is required to locate and repair such leaks. It is generally desirable to locate leaks before they become major problems since they can then be treated far more cost effectively and speedily. Once a leak becomes a major leak, then structural problems surrounding the underground pipeline can be encountered. These can include subsidence to thoroughfares and other serious engineering problems.

A problem with attempting to locate and treat leaks before they become major problems is the fact that the vast majority of all water carrying pipelines are located underground. Minor leaks may form without any visible sign being apparent from the surface. Therefore, there exists a need for a means of locating leaks in pipelines which obviates the need to excavate so as to examine the pipeline.

Furthermore, water supply companies often have difficulties with management of underground assets. For historical reasons, it is not always known what type of pipe (i.e. size, material) is in place under a particular road. Indeed, in some cases, the route followed by the pipe may not be known with any accuracy.

Embodiments of the present invention aim to provide a system whereby leaks may be identified using apparatus located inside the pipeline so that later remedial work can be targeted more closely and treated more appropriately. Embodiments also seek to provide a means of identifying different types of pipe for the purposes of building up information on underground assets.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

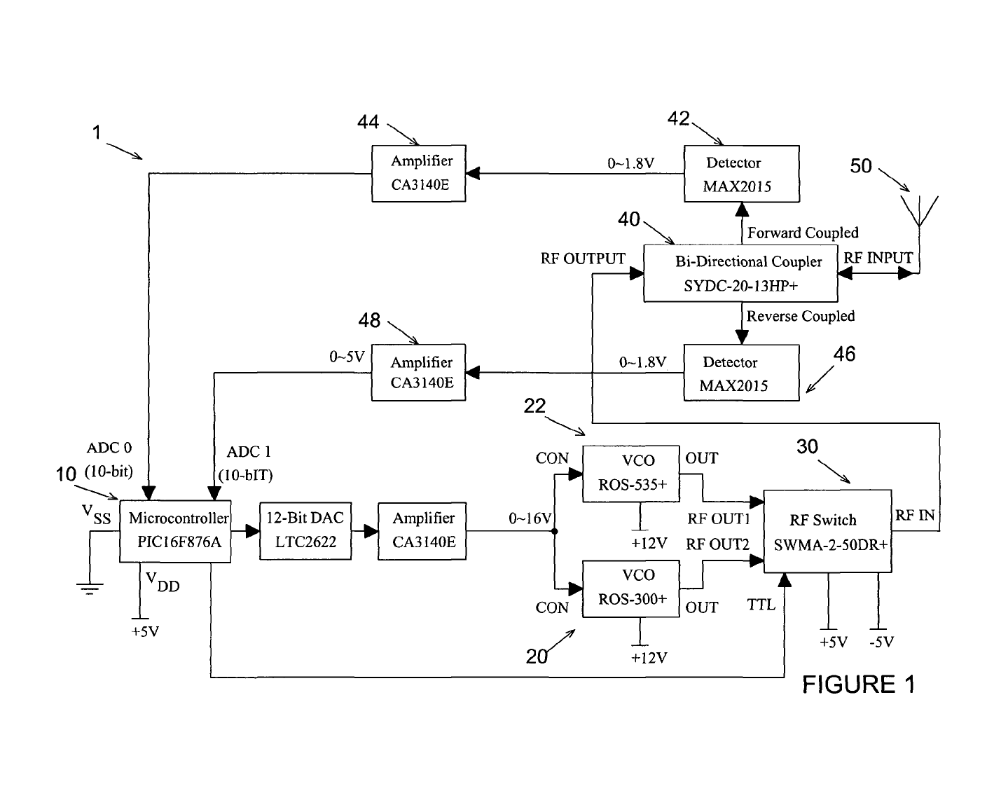

FIG. 1 shows a schematic of the circuitry of a probe according to an embodiment of the present invention;

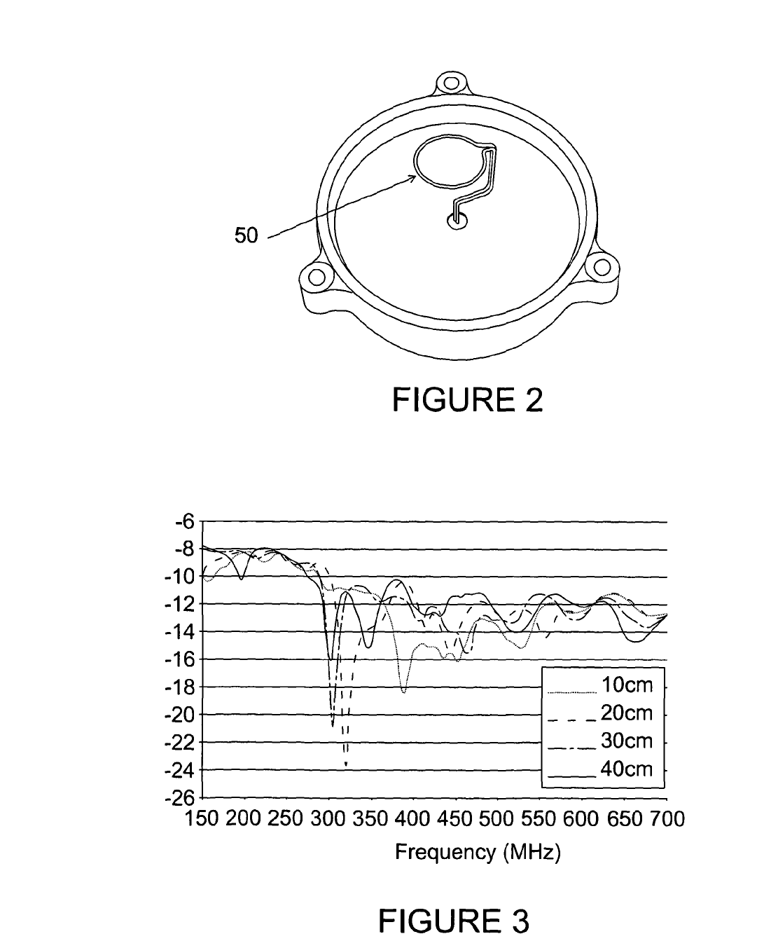

FIG. 2 shows a view of the antenna forming a part of an embodiment of the invention;

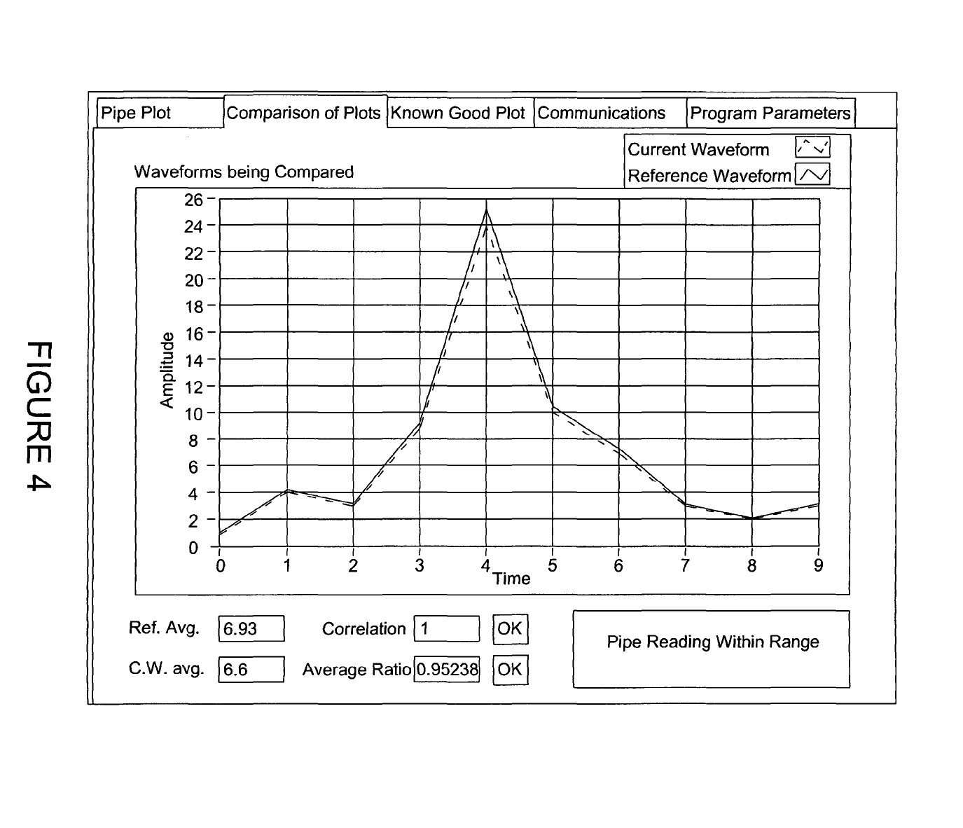

FIG. 3 shows the raw data resulting from a frequency sweep at different position relative to a leak in the pipeline;

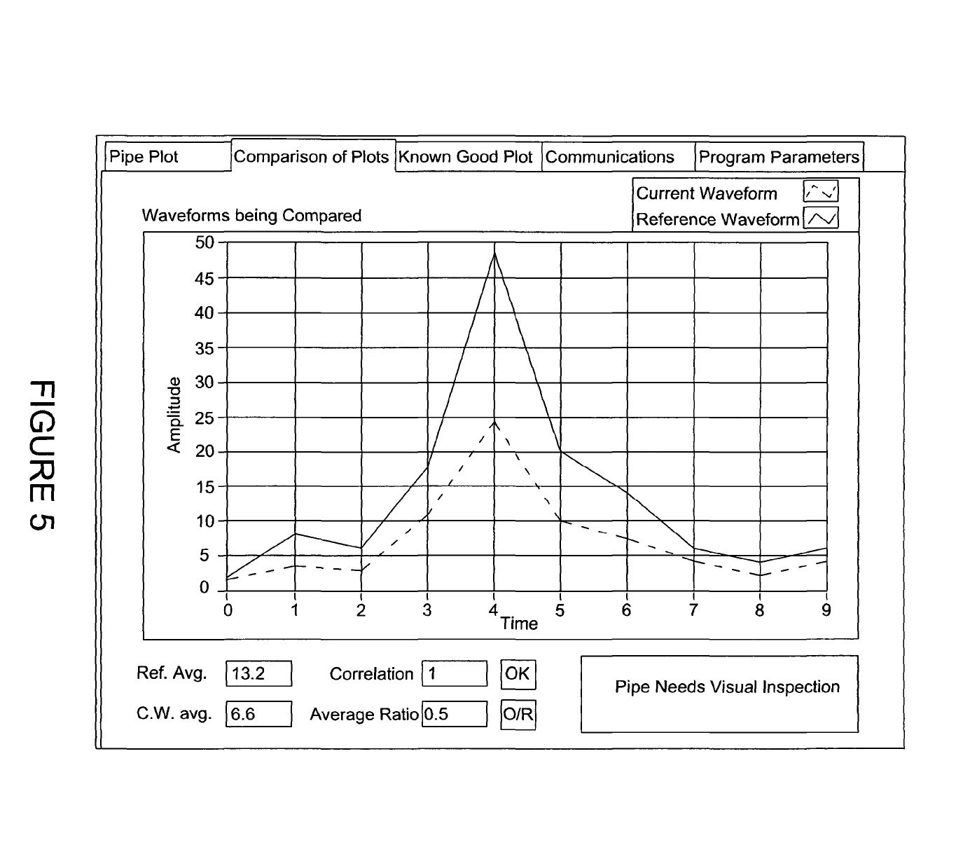

FIG. 4 shows a first typical user display;

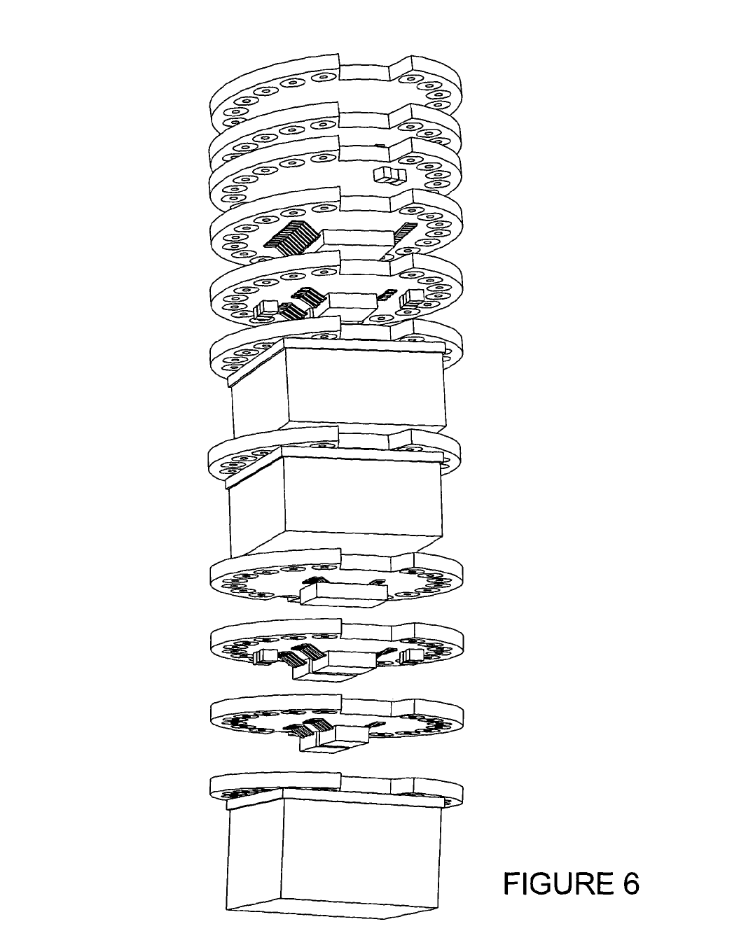

FIG. 5 shows a second typical user display; and

FIG. 6 shows a view of the construction of an embodiment of the present invention.

In order to understand a little of the background to embodiments of the present invention, it is instructive to consider some of the theory related to the propagation of electromagnetic (EM) waves in a pipe full of water. It is possible to consider a pipe full of water acting as a waveguide. A waveguide is a particular form of electrical transmission line more normally associated with microwave frequencies. If the pipe, however, is full of water or another liquid, it can still act as a waveguide but at much lower frequencies than in free space. This is due to the speed of the EM wave in such a situation, which is dependent on, amongst other factors, the conductivity of the liquid.

In free space, or a vacuum, an EM wave travels at the speed of light which is 3×10⁸ ms. The speed of an EM wave through any other material is affected by the relative permittivity εᵣ and the relevant permeability μᵣ of the material. The formula for the speed of an EM wave in any material other than free space is given by formula (1) below.

$$c = \frac{{c}_{vacuum}}{\sqrt{{ɛ}_{r} {μ}_{r}}} \qquad ( 1 )$$

In drinking water, at a temperature of approximately 15° C. the relative permittivity is approximately 81 and the relative permeability is 1. This leads to formula (2) which gives the speed of propagation in water as:

$${c}_{water} = \frac{3 \times {10}^{8}}{\sqrt{81 \times 1}} = 3.33 \times {10}^{7} m \text{/} s \qquad ( 2 )$$

Therefore, the speed of propagation of an EM wave in water is roughly 10 times lower than that of an empty pipe.

Electrical power is transported through a metal pipe by means of EM waves, which can take several different forms, depending on the particular mode pattern adopted. This pattern defines how the standing electric and magnetic fields appear in the pipeline. The two most important modes in use in embodiments of the present invention are called the TE₁₁ and the TM01 modes. The actual propagation modes depend on the physical characteristics of the pipe, and for most circumstances, the pipe can be considered as a waveguide of infinite length, when considering the propagation mode adopted.

In general, as the pipe diameter increases, the range of frequencies over which propagation is possible, reduces. There is a near linear correlation between the frequency at which propagation is possible and the pipe diameter.

These modes differ from EM waves in free space because they have to be higher than a certain minimum frequency in order to be able to propagate through the pipe at all. In a typical metal (cast-iron) water pipe, having a diameter of 4 inches (approximately 10 cm) the cut-off frequencies below which there is no propagation are 192 MHz for the TE₁₁ mode and 251 MHz for the TM₀₁ mode. Consequently, between the 192 MHz and 251 MHz points, only the TE₁₁ mode can propagate at all. For pipes having different diameters and/or composed of different material, then different frequency ranges apply.

The physical requirements of the probe forming an embodiment of present invention are obviously dictated, in part, by the dimensions of the pipe into which the probe is to be introduced. In order to ensure that the probe can move easily through the pipe, allowing for bends and other discontinuities, it is found that a probe having a diameter less than the typical pipe diameter (which is approximately 10 cm or 4 inches), and a length of less than 10 cm. The probe is attached to an electrical cable, which carries all the signals to/from the probe and the cable trails behind the probe, with readings being taken at selected intervals (e.g. every 10 cm) along the way. The cable must be physically strong enough to ensure that it can be used as a tether in this way. The flow of water through the pipe is used to convey it forward and the cable is used to pull it back to the source.

In order to introduce the probe into a live pressurised system, an adapted hydrant system is used, which is coupled to a suitable access point to the live system, and which allows the probe to be introduced in a controlled manner, without damaging the integrity of the water supply system.

FIG. 1 shows a schematic of the major circuit elements of the probe. The probe operates by transmitting a swept frequency signal in the range 200-550 MHz. The signal is transmitted from an antenna located at one end of the probe, and the same antenna is used to receive the signal. The antenna takes the form of a single loop antenna. It is found that a transmit output power of approximately 10 mW is suitable.

To produce a frequency sweep of 200-550MHz, it is necessary to use two separate Voltage Controlled Oscillators (VCOs) 20,22. The first VCO 20 is centred at 300 MHz, and the second VCO 22 is centred at 535 MHz. In order to produce a seamless or near seamless output signal, an RF switch 30 is provided which receives the output of each of the VCOs 20, 22 and switches between them under the control of microcontroller 10. The output of the RF switch 30 is then passed to bi-directional coupler 40 and on to the antenna 50.

If different frequency ranges are required, to allow the probe to be used in different pipe configurations, then the ranges of the respective VCOs can be adapted as necessary. Indeed, alternative or further VCOs can be provided, which can be switched as necessary to allow any desired range of frequencies to be accommodated.

The bi-directional coupler 40 allows both forward and reflected power to be measured. The forward power is detected by detector 42 and amplified by amplifier 44 before being fed back to microcontroller 10. The reverse or reflected power is detected by detector 46 and amplified by amplifier 48 before being fed back to microcontroller 10.

The antenna 50 is arranged as loop antenna folded back such that the plane of the loop is parallel to the diameter of the pipe, in use. In this way, the loop does not protrude from the front of the probe and so is more protected from accidental damage as it is introduced to and travels through the pipe. More importantly, however, by configuring the loop in this way, it is possible to integrate an optical system such that the optical sensor or camera can be positioned to look through the loop of the antenna, and not be obscured.

The details of the optical system are not included here and do not, in themselves, form part of the invention, but the interaction between them and the physical collocation of the antenna and the optical sensor is a feature of the invention and offers distinct advantages in allowing the optical sensor and the antenna to be located together at the front of the probe, where the performance of each can be optimised.

The optical system, if included in the probe, allows visual inspection of the interior of the pipe to complement the data received from the RF probe measurements. For instance, visual verification can assist in determining exact pipe configurations such as junctions, T-pieces, changes in pipe diameter/materials and similar discontinuities.

In use, the probe is introduced to the pipe system, and the RF circuitry is arranged to sweep the frequency range associated with the expected or known pipe conditions. The RF sweep signal is transmitted from the antenna 50, and then received back at the same antenna 50. An expected, predicted or calculated response is known and the received signal is compared to the expected response. The deviation from the expected signal is indicative of a non-conformity in the pipe. The nature and extent of the non-conformance is indicative of a leak in the pipe of some other irregularity which may or may not require further investigation. The associated optical system, if fitted, can be used to provide further evidence.

FIG. 3 shows how the resonant frequency changes with distance from a suspected leak. At a small distance (10 cm) from the site of the leak, the resonant frequency is approximately 380 MHz. As the distance from the leak increases to 40 cm, the resonant frequency decreases towards 300 MHz, which is the expected value for a normal pipe.

The operator of the probe would not typically be presented with waveforms of the sort shown in FIG. 3, although, there may be an advance option, allowing this form of raw data to be viewed and analysed.

FIG. 4 shows a typical display screen, visible to an operator. This particular example shows the results of a mathematical correlation performed on the received signals which indicates that the received signal correlates well with the expected response. This indicates to the operator that the pipe is within the expected or acceptable range.

FIG. 5, however, shows a typical display screen where the pipe has a leak and is therefore outside the acceptable range. The operator is warned that the pipe needs further attention.

In order to compare the received signal with the expected response, a correlation function can be used. In a preferred embodiment, a Pearson correlation function is used. If there is a perfect correlation, then a gradient of +1 results. If there is a gradient of −1, there is a perfect negative correlation. A 0 gradient indicates no correlation. By use of this function and the setting of an acceptable range, the condition of the pipe can be assessed and reported accordingly.

The raw data gathered by the probe is passed down the umbilical cable to a controlling PC or other data processor, which is programmed to analyse the data and display results to the operator so that the condition of the pipe can be recorded and areas of concern logged for possible future investigation.

The construction of the probe is largely dictated by the physical requirements that it fits easily into a given pipeline. The approach adopted is shown in FIG. 6. The circuitry of the probe is spread across a plurality of printed circuit boards (PCBs), each of which is approximately circular and houses a number of components. The various PCBs are interconnected and then housed within a waterproof housing for insertion into a pipeline.

As can be seen from the description of embodiments of the invention, by use of an RF probe as described, it is possible to investigate the condition of any pipeline in an unobtrusive manner, by maintaining the water supply, and monitoring the pipeline from inside. The data gathered can be used to provide information on the integrity of the pipeline and may also be used in asset management as the data gathered can be used to infer a number of different characteristics about the pipeline, including its size, material and configuration

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A probe for use in a fluid pipeline, comprising:
a transmitter for transmitting an RF signal via an antenna;
a receiver for receiving an RF signal via an antenna; and
a processor operable to compare the received signal with an expected signal.

2. The probe as claimed in claim 1 wherein the transmitter and the receiver are operable to transmit an RF signal and receive an RF signal. respectively, via a common antenna.

3. The probe as claimed in claim 1 wherein the transmitted RF signal is a swept range of frequencies.

4. The probe as claimed in claim 3 wherein the swept range of frequencies is selected based upon expected characteristics of the pipeline.

5. The probe as claimed in claim 2 wherein the common antenna is a loop antenna.

6. The probe as claimed in claim 5 further comprising a loop antenna folded such that a plane of the loop is parallel with a the diameter of the pipeline in use.

7. The probe as claimed in claim 6 further comprising an optical system located within the loop of the antenna so as to point towards a front of the probe in use.

8. The probe as claimed in claim 1 wherein the processor is operable compare the received signal with the expected signal using a correlation function and the degree of correlation is indicative of a condition of the pipeline.

9. The probe as claimed in claim 1 further comprising a plurality of interconnected circuit boards arranged substantially parallel inside a waterproof housing.

10. The probe as claimed in claim 1 wherein the probe is provided with an umbilical cable for attachment to a suitable processor.

11. A method of assessing the condition of a pipeline by means of a probe located inside the pipeline, comprising the steps of:
transmitting an RF signal from the probe;
receiving an RF signal at the probe; and
comparing the received and and an expected signal and, based on the result of the comparison, indicating that the pipeline is acceptable or not.

12. The method of claim 11, wherein the transmitting and the receiving are via an antenna.

13. The method of claim 12, wherein the transmitting and the receiving are via a single antenna.

14. The method of claim 13, wherein the antenna is a loop antenna.

15. The method of claim 11, wherein transmitting the RF signal includes transmitting a swept range of frequencies.
